(19) United States
(12) Patent Application Publication
(10) Pub. No.: US 2015/0117465 A1
(43) Pub. Date: Apr. 30, 2015

(54) COMMUNICATION CONTROL APPARATUS AND COMMUNICATION CONTROL METHOD

(71) Applicants: Kazuki Hamada, Tokyo (JP); Kenji Kitayama, Tokyo (JP); Kazunori Washio, Tokyo (JP); Satoru Takahashi, Tokyo (JP)

(72) Inventors: Kazuki Hamada, Tokyo (JP); Kenji Kitayama, Tokyo (JP); Kazunori Washio, Tokyo (JP); Satoru Takahashi, Tokyo (JP)

(73) Assignee: Mitsubishi Electric Corporation, Chiyoda-ku, Tokyo (JP)

(21) Appl. No.: 14/365,782

(22) PCT Filed: Nov. 7, 2012
(86) PCT No.: PCT/JP2012/078819

§ 371 Date: Jun. 16, 2014

(30) Foreign Application Priority Data
Feb. 24, 2012 (JP) 2012-038930

(51) Int. Cl. H04L 12/911; B66B 1/34

(52) U.S. Cl. CPC H04L 47/826; B66B 1/3446
USPC 370/458

(57) ABSTRACT

A communication control apparatus includes a high-reliability-signal transmission and reception control unit configured to perform control for continuously transmitting the high-reliability signal a specified number of times according to transmission timing specified within a transmission period, a transmission scheduler unit configured to calculate, on the basis of the specified transmission timing, a free time in which the high-reliability signal is not transmitted, and a non-high-reliability-signal transmission and reception control unit configured to perform, when the non-high-reliability signal cannot be transmitted within the free time, control for dividing the non-high-reliability signal into a size transmittable in the free time and transmitting the non-high-reliability signal as two or more packets. The transmission scheduler unit transmits the high-reliability signal at the specified transmission timing and transmits the divided non-high reliability signal in the free time.

### FIELD

The present invention relates to a communication control apparatus that performs communication among apparatuses from which an elevator is configured.

### BACKGROUND

Among apparatuses included in an elevator, signals related to the operation of the elevator and requiring high reliability (hereinafter referred to as high-reliability signals) and signals not requiring high reliability such as BGM (hereinafter referred to as non-high-reliability signals) are exchanged. The apparatuses generate a series circuit with a plurality of devices such as sensors and switches, detect an input of a high-reliability signal according to whether the voltage is ON or OFF, and determine whether the apparatuses are in a high-reliability state. Concerning non-high-reliability signals, an exclusive signal line is prepared for each of the devices/functions. The devices perform communication according to an arbitrary communication system determined for each of the apparatuses.

Meanwhile, in recent years, a system has been proposed for applying digitization to signals output from the devices such as sensors and switches and performing digitization of systems. By realizing the digitization, reliability is improved compared with that of a conventional elevator. Further, it is possible to realize communication of the high-reliability signals with a considerably small number of signal lines by integrating the signals. Therefore, the system is useful from the viewpoint of cost reduction as well.

Concerning the elevator, standards for reliability are set in each country. In the digitization of the high-reliability signals, design satisfying the standards is necessary. For example, Patent Literatures 1 and 2 disclose technology for realizing digitization and networking of high-reliability signals while satisfying the standards.

### CITATION LIST

### Patent Literature

Patent Literature 1: Japanese Translation of International Patent Application No. 2002-538061

Patent Literature 2: Japanese Patent Application Laid-Open No. 2010-193039

### SUMMARY

### Technical Problem

However, according to the related art, types of signals to be integrated are only high-reliability signals or high-reliability signals and signals for controlling the elevator (hereinafter referred to as control signal). Because these signals are generally periodic signals, priority control and the like corresponding to the signal types were not necessary.

Meaenwhile, when the non-high-reliability signals are integrated with the high-reliability signals, because the non-high-reliability signals include non-periodic signals, there is a problem in that priority control corresponding to the signal types is necessary to prevent communication of the non-high-reliability signals from affecting communication of the high-reliability signals. Further, the high-reliability signals are requested to be transmitted at a short period. There is a problem in that it is difficult to transmit the non-high-reliability signals having a large size without affecting transmission and reception of the high-reliability signals.

The present invention has been devised in view of the above and it is an object of the present invention to obtain a communication control apparatus capable of realizing efficient communication of the non-high-reliability signals without affecting the communication of the high-reliability signals.

### Solution to Problem

In order to solve the aforementioned problems, a communication control apparatus that integrates a high-reliability signal requiring high reliability and a non-high-reliability signal not requiring high reliability and performs communication between a car and a control apparatus configuring an elevator, wherein the communication control apparatus is mounted on the car and the control apparatus, according to one aspect of the present invention is configured to include: a high-reliability-signal transmission and reception control unit configured to perform control for continuously transmitting the high-reliability signal for a specified number of times according to the transmission timing specified within a transmission period; a transmission scheduler unit configured to calculate, on the basis of the specified transmission timing, a free time in which the high-reliability signal is not transmitted; and a non-high-reliability-signal transmission and reception control unit configured to perform, when the non-high-reliability signal cannot be transmitted within the free time, control for dividing the non-high-reliability signal into a size transmittable in the free time and for transmitting the non-high-reliability signal as two or more packets, wherein the transmission scheduler unit transmits the high-reliability signal at the specified transmission timing and transmits the divided non-high reliability signal in the free time.

### Advantageous Effects of Invention

The communication control apparatus and the communication control method according to the present invention have an effect whereby it is possible to realize efficient communication of the non-high-reliability signals without affecting the communication of the high-reliability signal.

### BRIEF DESCRIPTION OF DRAWINGS

FIG. 1 is a diagram of a configuration example of an elevator apparatus.

FIG. 2 is a diagram of a configuration example of a communication control apparatus in a first embodiment.

FIG. 3 is a diagram explaining communication systems for a high-reliability signal.

FIG. 4 is a flowchart explaining a communication control method of the communication control apparatus in the first embodiment.

FIG. 5 is a flowchart explaining a communication control method that takes into account a response to a counter apparatus in the communication control apparatus.

FIG. 6 is a flowchart explaining a communication control method that takes into account a response to the counter apparatus and a response from the counter apparatus in the communication apparatus.

FIG. 7 is a diagram explaining a transmission packet in a third embodiment.

FIG. 8 is a diagram of a configuration example of a communication control apparatus in the third embodiment.

FIG. 9 is a flowchart explaining a communication control method of the communication control apparatus in the third embodiment.

### DESCRIPTION OF EMBODIMENTS

Embodiments of a communication control apparatus according to the present invention are explained in detail below with reference to the drawings. The present invention is not limited by the embodiments.

### First Embodiment.

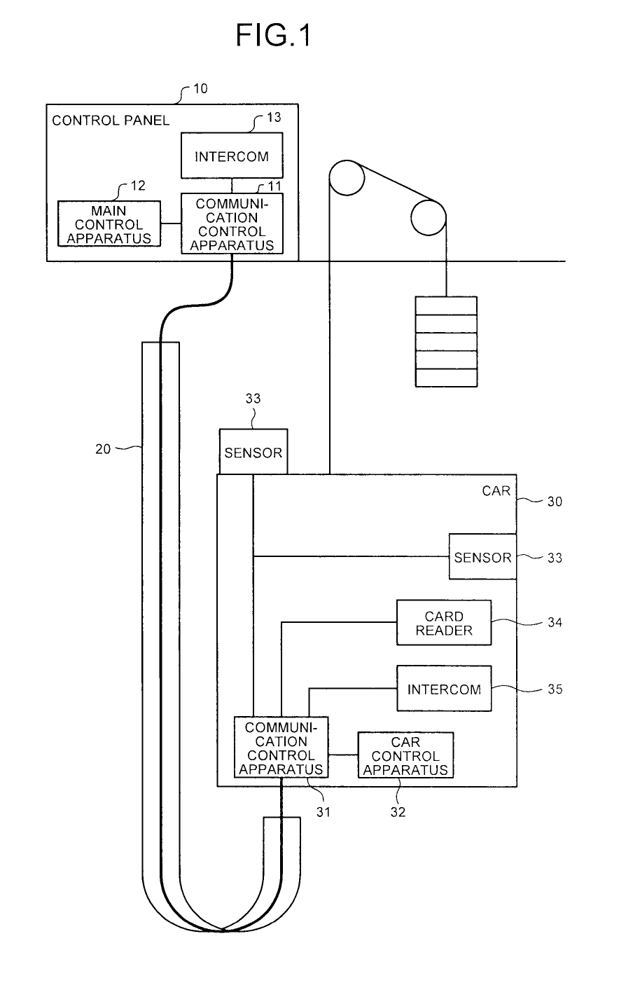

FIG. 1 is a diagram of a configuration example of an elevator apparatus according to the first embodiment. The elevator apparatus includes a control panel 10, an elevator control cable 20, and a car 30. In general, the control panel 10, which is a control device set in a machine room and configured to control the operation of an elevator, and the car 30, which users get on and off, communicate via the elevator control cable 20.

The control panel 10 includes a communication control apparatus 11, a main control apparatus 12, and an intercom 13.

The communication control apparatus 11 controls communication between the car 30 and the control panel 10.

The main control apparatus 12 performs management and control of sensors set in the car, a hoistway, and the like and of the entire elevator. The main control apparatus 12 performs communication using high-reliability signals.

The intercom 13 is a peripheral device set in the control panel 10 and performs audio communication and the like with the car 30 side. The intercom 13 (the peripheral device) performs communication using non-high-reliability signals.

The elevator control cable 20 is a cable for connecting the control panel 10 and the car 30 and includes a communication line used for integrated communication.

The car 30 includes a communication control apparatus 31, a car control apparatus 32, sensors 33, a card reader 34, and an intercom 35.

The communication control apparatuses 11 and 31 control communication between the car 30 and the control panel 10.

The car control apparatus 32 performs processing such as door opening and closing of the car 30 according to commands from the main control apparatus 12 of the control panel 10. The car control apparatus 32 performs communication using the high-reliability signal.

The sensors 33 are set inside the car 30 and outside the car 30. The sensors 33 acquire the state of the elevator and notify the main control apparatus 12 of the control panel 10 of the state via the communication control apparatus 31. The sensors 33 perform communications using the high-reliability signals. Note that, in general, sensors are also set in the hoistway and the like. However, because the sensors do not affect operations according to this embodiment, explanation of the sensors is omitted.

The card reader 34 and the intercom 35 are peripheral devices set in the car 30, wherein the card reader 34 performs authentication and the like of a card holder. The intercom 35 performs audio communication and the like with the control panel 10 side. Note that the card reader 34 and the intercom 35 are shown as examples of the peripheral devices. However, the peripheral devices are not limited to the card reader 34 and the intercom 35. For the peripheral devices, for example, there are a monitor camera and an intra-car BGM reproducing device. Besides, the peripheral devices include all devices excluding devices related to communication by the high-reliability signals among devices for performing communication such as a general-purpose I/F for Ethernet (registered trademark) communication.

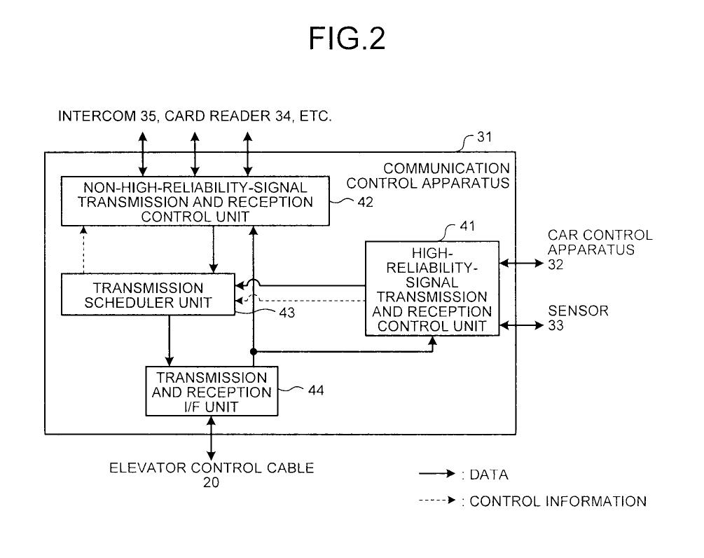

The configuration of the communication control apparatuses 11 and 31 is explained here. The communication control apparatuses 11 and 31 have the same configuration except that some parts of the devices connected thereto are different. As an example, the communication control apparatus 31 is used for explanation. FIG. 2 is a diagram of a configuration example of the communication control apparatus 31 of this embodiment. The communication control apparatus 31 includes a high-reliability-signal transmission and reception control unit 41, a non-high-reliability-signal transmission and reception control unit 42, a transmission scheduler unit 43, and a transmission and reception I/F unit 44. Compared with the communication control apparatus 31, some parts of devices such as the sensors 33 are not connected to the communication apparatus 11. The car control apparatus 32 is replaced with the main control apparatus 12.

The high-reliability-signal transmission and reception control unit 41 generates the high-reliability signals on the basis of information received from the sensors 33 and the car control apparatus 32, performs processing necessary for successive transmission or a response request according to the policy of high-reliability signal communications, which is transmission timing specified in a transmission period, and then transfers the generated high-reliability signals to the transmission scheduler unit 43. The high-reliability-signal transmission and reception control unit 41 provides the transmission scheduler unit 43 with, as control information, information concerning the presence or absence of use of the response request according to the policy of the high-reliability signal communication and the number of successive transmissions.

The non-high-reliability-signal transmission and reception control unit 42 receives a transmission request from a connected peripheral device such as the intercom 35 or the card reader 34, receives information (control information) concerning a transmittable packet size from the transmission scheduler unit 43, and then generates a packet (a non-high-reliability signal) having an appropriate size and transfers the packet to the transmission scheduler unit 43.

The transmission scheduler unit 43 controls processing timing for transmission. The transmission scheduler unit 43 preferentially transfers high-reliability signals, which are received from the high-reliability-signal transmission and reception control unit 41, to the transmission and reception I/F unit 44 (according to the specified transmission timing). The transmission scheduler unit 43 calculates, on the basis of the information concerning the presence or absence of use of the response request and the number of successive transmissions obtained from the high-reliability-signal transmission and reception control unit 41, the time in which the non-high-reliability signals can use a communication path and provides, on the basis of the calculated time, the non-high-reliability-signal transmission and reception control unit 42 with the information (the control information) concerning the transmittable packet size.

The transmission and reception I/F unit 44 outputs the signals (the high-reliability signals and the non-high-reliability signals) received from the transmission scheduler unit 43 to the elevator control cable 20. Concerning signals input from the elevator control cable 20, according to signal types, the transmission and reception I/F unit 44 transfers the high-reliability signal to the high-reliability-signal transmission and reception control unit 41 and transfers the non-high-reliability signals to the non-high-reliability-signal transmission and reception control unit 42.

A standard concerning the high-reliability signal and a conventional communication system are explained here. Concerning the high-reliability signal, requested reliability and responsiveness are specified in each standard. Communication based on standards needs to be performed. For example, besides the standard IEC61508 (Function safety of electrical/electronic programmable electronic safety-related systems) specified by the IEC (International Electrotechnical Commission), which is an international standard, national standards are present in each country. Communication systems need to respectively satisfy the national standards of each country where products are used.

For a communication system that satisfies a high-reliability standard, a method of performing communication using successive transmission and a communication system for performing communication using both of successive transmission and an ACK request (Acknowledgement, a response request) have been proposed. The quality of a communication path is measured at any time and the number of successive transmissions is varied according to the quality level. Therefore, the high-reliability-signal transmission and reception control unit 41 of the communication control apparatuses 11 and 31 can perform communication of the high-reliability signals using any one of the conventional communication systems. Concerning which of the systems performs the high-reliability signal communication, it is possible to select the system considered to be more appropriate by taking into account characteristics of the communication path such as the communication delay between apparatuses.

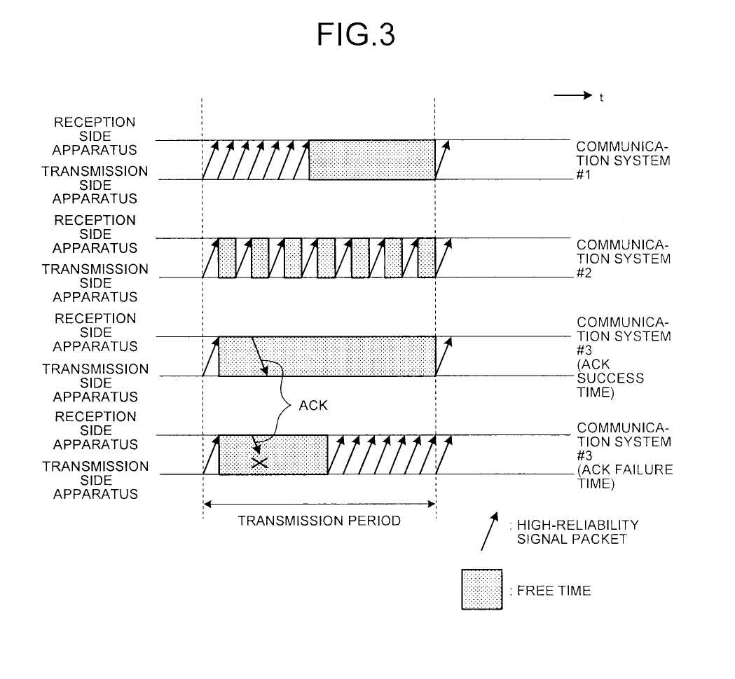

FIG. 3 is a diagram explaining communication systems for the high-reliability signal. The abscissa indicates time and shows a time chart for transmitting a packet of a high-reliability signal from a transmission side apparatus to a reception side apparatus. A communication system #1 measures the bit error rate of the communication path and successively transmits the high-reliability signal according to the number of successive transmissions calculated on the basis of the result of the measurement to realize securing of desired reliability and responsiveness.

A communication system #2 is a communication system obtained by expanding the communication system #1. It is empirically known that the bit error in a communication path often occurs in a burst-like manner. Therefore, by dispersing the timing of successive transmissions of the high-reliability signals over an allowable range, it is possible to improve resistance to burst-like bit errors. Note that both the numbers of successive transmissions in the communication systems #1 and that of #2 are set to seven. However, this is only an example. The number of successive transmissions is changed every moment according to transmission path quality.

A communication system #3 is a communication system for performing communication of the high-reliability signals using both of the response request and the successive transmission. In a communication system that uses response requests, it is possible to explicitly confirm that information has reached a counter apparatus (when the transmission side apparatus is an own apparatus in FIG. 3, corresponding to the reception side apparatus) (at ACK success time). However, in the case of failure in communication (at ACK failure time), retransmission needs to be performed and it is difficult to ensure its responsiveness. Therefore, in the communication system #3, by performing retransmission using successive transmission at the time of failure in communication by the response request, reliability and responsiveness requested for the high-reliability signals are realized.

On the other hand, when reliability and responsiveness cannot be sufficiently secured in the non-high-reliability signals, it is likely that sound quality deterioration of the intercoms 13 and 35, a response delay of the card reader 34, and the like are caused. However, the effects of the sound deterioration, the response delay, and the like are allowable effects compared with the effects when reliability and responsiveness cannot be ensured in the high-reliability signals. Therefore, in this embodiment, the communication of the high-reliability signals is given highest priority. Communication of the non-high-reliability signals is performed in a free time. That is, in FIG. 3, time clearly indicated as the free time is used for low-reliability communication.

A non-high-reliability signal includes various signals such as a general-purpose Ethernet signal besides signals in the intercoms 13 and 35 and the card reader 34. Packet sizes of the signals are also various. For example, in a serial communication such as RS232, the size of one piece of data is one byte. In the general-purpose Ethernet, the size of one piece of data is 64 to 1522 bytes. However, as shown in FIG. 3, the size of the free time usable for the low-reliability communication is limited. For example, in the communication system #1, when a period is set to 1 ms and the number of successive transmissions is set to seven, a transmittable packet size of the non-high-reliability signal is up to 642 bytes. When the communication system #2 is used under the same conditions, the transmittable packet size is up to 74 bytes. The period and the number of successive transmissions are not limited to the conditions explained above. Even when the conditions are changed, the transmittable packet size is limited.

When it is attempted to directly transmit a packet of a non-high-reliability signal exceeding a usable size of the free time, the two kinds of processing explained below are conceivable.
1. The communication of the high-reliability signal is delayed and transmission of a non-high-reliability signal packet is completed.
2. The communication of the non-high-reliability signal is suspended halfway and the high-reliability signal is transmitted according to scheduling of the high-reliability signal (the non-high-reliability signal being transmitted is discarded).

However, in the processing of 1, it is difficult to ensure reliability and responsiveness of the high-reliability signals. Because the high-reliability signals are periodic signals, when the processing of 2 is adopted, a phenomenon in which communication is never successful is likely to occur.

Therefore, in this embodiment, concerning a packet of a non-high-reliability signal exceeding the usable size of the free time, processing for dividing and transmitting the packet is performed.

For example, when a divided size is set to the smallest length transmittable by the communication path, the probability of successful transmission is made highest irrespective of the communication system and the number of successive transmissions of the high-reliability signal. However, in packet communication such as Ethernet, because a header and a footer, an inter-frame gap called IFG (Inter Frame Gap), a preamble, and the like are necessary, transmission efficiency of an actual data portion deteriorates according to the increase in the number of packets. Therefore, by appropriately changing the divided size of the packet according to the communication system and the number of successive transmissions of the high-reliability signal, it is possible to improve transmission efficiency of non-high-reliability signals without affecting the communication of the high-reliability signals.

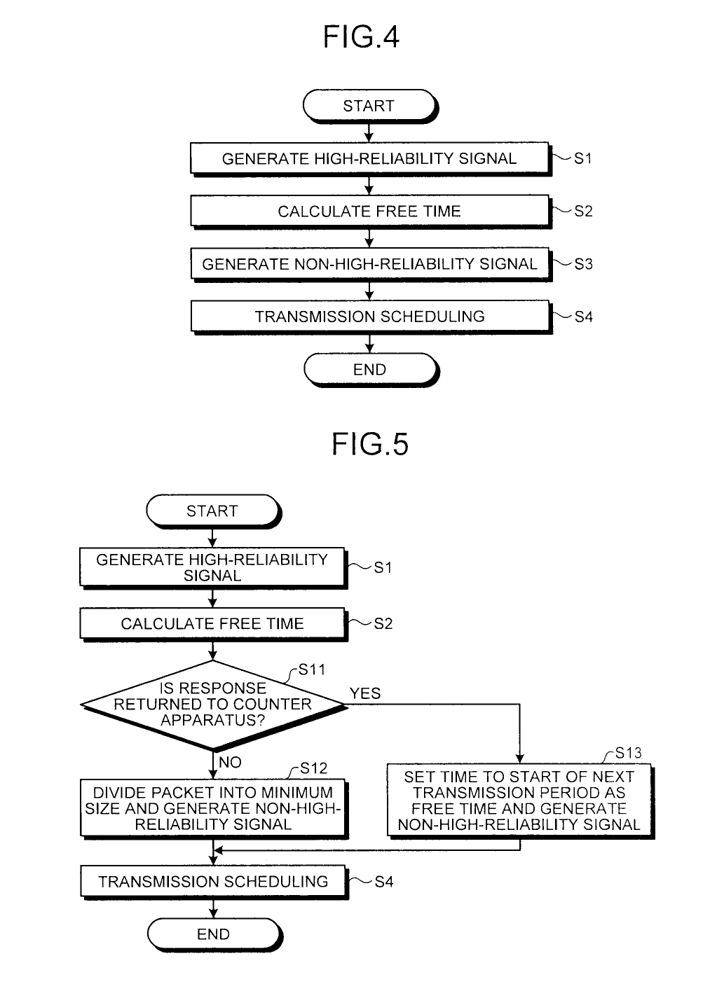

A method of calculating the divided size of a packet and transmitting a non-high-reliability signal is specifically explained here. FIG. 4 is a flowchart explaining a communication control method of the communication control apparatus in this embodiment. When the communication system #1 or #2 is used as the communication system for a high-reliability signal, the high-reliability-signal transmission and reception control unit 41 determines a transmission method and the number of successive transmissions for transmitting the high-reliability signal within a transmission period and generates a packet of the high-reliability signal on the basis of the transmission timing specified by the determined transmission method and the determined number of successive transmissions (step S1).

At the beginning of each transmission period, the transmission scheduler unit 43 acquires information concerning the transmission method and the number of successive transmissions at that point from the high-reliability-signal transmission and reception control unit 41. Because the number of successive transmissions changes according to the situation along the communication path, the transmission scheduler unit 43 acquires the latest information at every period or at least every fixed period and reflects the latest information on the operation. The transmission scheduler unit 43 carries out scheduling of the high-reliability signal on the basis of the information obtained from the high-reliability-signal transmission and reception control unit 41 and calculates, from the result of the scheduling, a free time in which the high-reliability signal is not transmitted (step S2). The transmission scheduler unit 43 notifies the non-high-reliability-signal transmission and reception control unit 42 of the information concerning the free time.

When the size of the non-high-reliability signal cannot be transmitted within the notified free Lime, the non-high-reliability-signal transmission and reception control unit 42 divides, on the basis of the information obtained from the transmission scheduler unit 43, the packet of the non-high-reliability signal into two or more packets in a size that fits in the free time and generates a packet of the non-high-reliability signal (step S3).

The transmission scheduler unit 43 performs scheduling of the divided non-high-reliability signal using the free time (step S4).

As explained above, the communication control apparatus 11, 31 transmits, irrespective of a transmission situation of a non-high-reliability signal, the high-reliability signal at the timing determined by the transmission scheduler unit 43 in the beginning of the transmission period. However, when the communication control apparatus 11, 31 is transmitting the high-reliability signal using the communication system #2, when data to be transmitted is absent or when the remaining time until the next high-reliability signal transmission is shorter than the time necessary for transmission of the shortest packet transmittable along the communication path at a point when transmission of one non-high-reliability signal being transmitted is completed, the communication control apparatus 11, 31 can immediately transmit the high-reliability signal scheduled to be transmitted next. Consequently, it is possible to reduce as much as possible a state in which the communication path cannot be substantially used and attain improvement of communication efficiency.

The use of the communication system #3 as the communication system for the high-reliability signal is explained here. When the communication system #3 is used as the communication system for the high-reliability signal, the communication control apparatus 11, 31 determines, according to whether a response to the high-reliability signal transmitted by the own apparatus is returned, whether it is necessary to perform the successive transmission at the end of the transmission period. That is, before a response is obtained from the counter apparatus side (when the own apparatus is the control panel 10, the car 30 and, when the own apparatus is the car 30, the control panel 10), the transmission scheduler unit 43 cannot determine whether successive transmission is necessary. When transmission and reception of the high-reliability signal is performed bidirectionallly (in general, the transmission and reception is performed bidirectionally), processing for returning a response to the high-reliability signal transmitted from the counter apparatus is necessary. A prompt return of the response is requested. If the return of the response is delayed, the counter apparatus determines that the response has not arrived and starts successive transmission processing. As a result, it is likely that the delay in returning the response is equivalent to no response.

Taking the above into consideration, in this embodiment, from the reception of the high-reliability signal from the counter apparatus until a processing series for returning a response is completed, the communication control apparatus 11, 31 divides a packet of the non-high-reliability signal into the smallest packet length set for a communication path used for transmission and performs the transmission, and after the processing series is completed; it sets a limit packet size, transmission of which can be completed within the same period, as the largest value, that is, immediately before transmission of the next high-reliability signal (transmission period) is started; and performs packet division such that the packet fits within the range of the packet size. Consequently, compared with a case in which a packet is always divided into the smallest packet length, it is possible to efficiently transmit the non-high-reliability signal.

FIG. 5 is a flowchart explaining a communication control method that takes into account a response to the counter apparatus in the communication control apparatus. Because steps S1, S2, and S4 are the same as the steps in FIG. 4, explanation of these steps is omitted. When the own apparatus has not received a high-reliability signal from the counter apparatus or has not returned a response to a high-reliability signal received from the counter apparatus within a transmission period (No at step S11), the non-high-reliability-signal transmission and reception control unit 42 performs control for dividing a packet of the non-high-reliability signal into the smallest size specified by a communication path used for transmission of the non-high-reliability signal, generating the non-high-reliability signal, and transmitting the non-high-reliability signal (step S12). When the own apparatus has returned a response to the high-reliability signal received from the counter apparatus (Yes at step S11), the non-high-reliability-signal transmission and reception control unit 42 performs control for setting, as a free time, time from the return of the response to the start of the next transmission period, dividing the non-high-reliability signal untransmittable in the free time into two or more packets of a size transmittable in the free time, generating the non-high-reliability signal, and transmitting the non-high-reliability signal (step S13).

Note that, when a response request packet is transmitted to the counter apparatus, when it is possible to detect the limit transmission timing at which the counter apparatus recognizes the response and does not perform retransmission by a successive transmission, the non-high-reliability-signal transmission and reception control unit 42 can calculate the time from a transmission point of the non-high-reliability signal to the transmission timing and set a packet length, transmission of which is completed within the time, as the largest packet length in the non-high-reliability signal. Consequently, it is possible to more effectively transmit the non-high-reliability signal.

further, when a response to the high-reliability signal transmitted by the own apparatus has not returned as explained above, the communication control apparatus 11, 31 needs to perform retransmission of the high-reliability signal by successive transmission. At this point, when the non-high-reliability signal is being transmitted, if the transmission of the non-high-reliability signal is suspended and the transmission of the high-reliability signal is performed, deterioration in transmission efficiency is caused. Therefore, when the communication control apparatus 11, 31 has received the high-reliability signal from the counter apparatus and have already responded and has not received a response to the high-reliability signal transmitted from the own apparatus, assuming that retransmission by the successive transmission is performed in the end of the transmission period, the communication control apparatus 11, 31 can set a packet length, transmission of which can be completed within the time from a point at which transmission of the non-high-reliability signal is performed to the start of retransmission by the successive transmission as the largest packet length of the non-high-reliability signal. When the communication control apparatus 11, 31 has received the response to the high-reliability signal transmitted from the own apparatus, the communication control apparatus 11, 31 can set a packet length, transmission of which can be completed within the time from the transmission start point of the non-high-reliability signal to the transmission start timing of the next high-reliability signal (i.e., the end of the transmission period) as the largest packet length of the non-high-reliability signal. Consequently, when retransmission by the successive transmission is unnecessary, it is possible to allocate time for the retransmission to transmission of the non-high-reliability signal. It is possible to efficiently transmit the non-high-reliability signal.

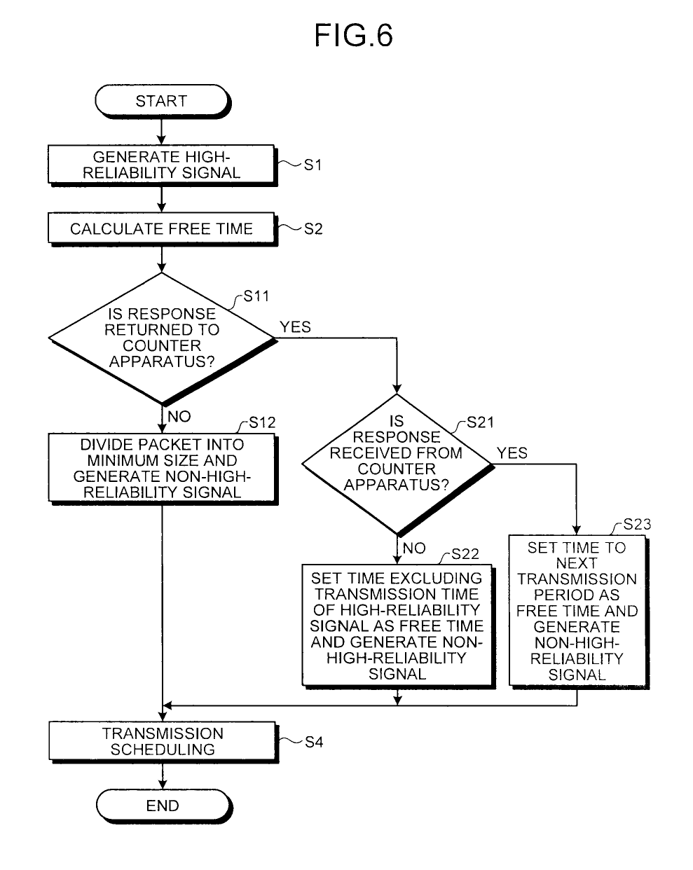

FIG. 6 is a flowchart explaining a communication control method that takes into account a response to the counter apparatus and a response from the counter apparatus in the communication control apparatus. Because steps S1, S2, and S4 are the same as the steps in FIGS. 4 and 5, explanation of these steps is omitted. When the own apparatus has not received the high-reliability signal from the counter apparatus or has not returned a response to the high-reliability signal received from the counter apparatus within a transmission period (No at step S11), the non-high-reliability-signal transmission and reception control unit 42 performs control for dividing a packet of the non-high-reliability signal into a smallest size specified by a communication path used for transmission of the non-high-reliability signal and transmitting the non-high-reliability signal (step S12). On the other hand, when the own apparatus has returned a response to the high-reliability signal received from the counter apparatus (Yes at step S11), the non-high-reliability-signal transmission and reception control unit 42 performs control for returning a response to the high-reliability signal received from the counter apparatus. When the own apparatus has not received, from the counter apparatus, a response to the high-reliability signal transmitted from the own apparatus (No at step S21), the non-high-reliability-signal transmission and reception control unit 42 performs control for setting, as a free time, the time excluding processing time necessary for transmitting the high-reliability signal within the transmission period and transmitting the non-high-reliability signal (step S22). When the own apparatus has returned a response to the high-reliability signal received from the counter apparatus and has received, from the counter apparatus, a response to the high-reliability signal transmitted from the own apparatus (Yes at step S21), the non-high-reliability-signal transmission and reception control unit 42 performs control for setting, as a free time, the time from the later one of the return of a response to the counter apparatus and reception of a response from the counter apparatus till the start of the next transmission period and transmitting the non-high-reliability signal (step S23).

However, when a communication path having a sufficiently low bit error rate and that is predicted to have a sufficiently high probability of return of a response to the initial high-reliability signal transmission is used, in the communication control apparatuses 11, 31, the non-high-reliability-signal transmission and reception control unit 42 can determine, without assuming retransmission of the high-reliability signal by the successive transmission from the own apparatus, the largest packet length in the non-high-reliability signal in accordance with a completion of the processing series for receiving the high-reliability signal from the counter apparatus and then return a response. When a communication path having a sufficiently small probability of occurrence of a bit error is used, in general, this communication system is higher in overall efficiency.

As explained above, the method of dividing the packets of a non-high-reliability signal and transmitting the packet of the non-high-reliability signal at the timing when the high-reliability signal is not transmitted is a method of realizing integrated communication using a communication system in a narrow band. Therefore, usability is high when the integrated communication is performed using a communication in a relatively narrow band such as 10BASE-T. For example, it is possible to apply the communication system explained in the embodiment to a communication system in a wider band such as 100BASE-T. However, because sufficient performance is obtained even if the communication system in this embodiment is not applied, there is almost no effect by the application of the communication system.

On the other hand, compared with the communication system in the wide band such as 100BASE-T, in inexpensive low band communication, by applying the communication system of this embodiment, it is possible to realize integration of the communication of the high-reliability signal and the communication of the non-high-reliability signal. In particular, industrial applicability is large in terms of realization costs.

As explained above, in this embodiment, when periodically performing the communication of the high-reliability signal in the sensors and the like, the communication control apparatus 11, 31 set in the control panel 10 or the car 30 included in the elevator divides, using the free time by the communication of the high-reliability signal, the packet of the non-high-reliability signal into a size transmittable in the free time and transmits the packet. Consequently, in the communication control apparatus 11, 31, it is possible to realize efficient communication of the non-high reliability signal without affecting the communication of the high-reliability signal.

### Second Embodiment

In this embodiment, transmission of a non-high-reliability signal having periodicity is explained. Differences from the first embodiment are explained here.

Among non-high-reliability signals, for example, there are signals having periodicity, such as an intercom signal. Concerning the signals having periodicity, the transmission scheduler unit 43 can improve real-time properties by performing scheduling to always transmit the signals at the same timing within a transmission period. When successive transmission of a high-reliability signal is dispersed, the transmission scheduler unit 43 can reduce the short free time unusable for communication as much as possible and improve communication efficiency by changing some parts of a packet transmission interval of the high-reliability signal.

When communication of the high-reliability signal is performed using the communication system #2, the transmission scheduler unit 43 schedules a periodic non-high-reliability signal between a high-reliability signal N (Nth in the successive transmission) and a high-reliability signal N+1 (N+1th in the successive transmission). As a result, when the free time between the high-reliability signal N and the high-reliability signal N+1 is equal to or smaller than 64 Bytes, the free time cannot be utilized. In such a case, the transmission scheduler unit 43 adjusts beforehand transmission timings of the high-reliability signal N, the high-reliability signal N+1, and the periodic non-high-reliability signal to prevent free time from being formed, that is, to change an interval for successively transmitting the high-reliability signals. Consequently, it is possible to expect further improvement in communication efficiency.

### Third Embodiment

In this embodiment, one transmission packet is configured from a high-reliability signal and a non-high-reliability signal. Differences from the first and second embodiments are explained here.

The first and second embodiments are based on the premise that the high-reliability signals and the non-high-reliability signals are always stored in separate packets to perform communication. The amount of information carried by the high-reliability signals is small because the high-reliability signals are, for example, contact information of sensors and the like or opening and closing information of a door. Therefore, in general, the size of the packet storing only the high-reliability signal is small. For example, a transmittable smallest packet length is specified in many communication systems such as Ethernet. When a packet size is smaller than the smallest packet length, in general, the packet size is adjusted to the smallest packet length by padding.

However, because a padding portion does not include significant information, an increase in the padding region causes deterioration in transmission efficiency. Therefore, in this embodiment, when there is a non-high-reliability signal waiting for transmission at a transmission point of the high-reliability signal, the communication control apparatus divides a head portion of the non-high-reliability signal into a size equal to the padding region of the high-reliability signal and stores the divided non-high-reliability signal in the padding region to thereby realize improvement of communication efficiency. At this point, when the high-reliability signal is a successive transmission packet, the communication control apparatus can insert different non-high-reliability signals respectively in padding portions of each packet.

Note that, when the data size of a non-high-reliability signal waiting for transmission before division is 64 bytes, even if the non-high-reliability signal is divided, the total data size necessary for transmission does not decrease. In such a case, the communication control apparatus does not have to perform processing for dividing the non-high-reliability signal and storing the non-high-reliability signal in the padding region of the high-reliability signal. Note that, when the padding region is present in the high-reliability signal irrespective of the data size of the non-high-reliability signal, the communication control apparatus can have specifications for dividing the non-high-reliability signal and storing the non-high-reliability signal in the padding region of the high-reliability signal. However, in this case, performance improvement effect (improvement of communication efficiency) is not obtained by performing the division.

When padding is already included in the non-high-reliability signal itself waiting for transmission and the total size of the actual data portions (portions obtained by excluding the padding from the payload portions of Ethernet frames) of the high-reliability signal and the non-high-reliability signal is a size that fits within 64 bytes, which is the smallest size of an Ethernet frame, two packets can be integrated and transmitted as one packet.

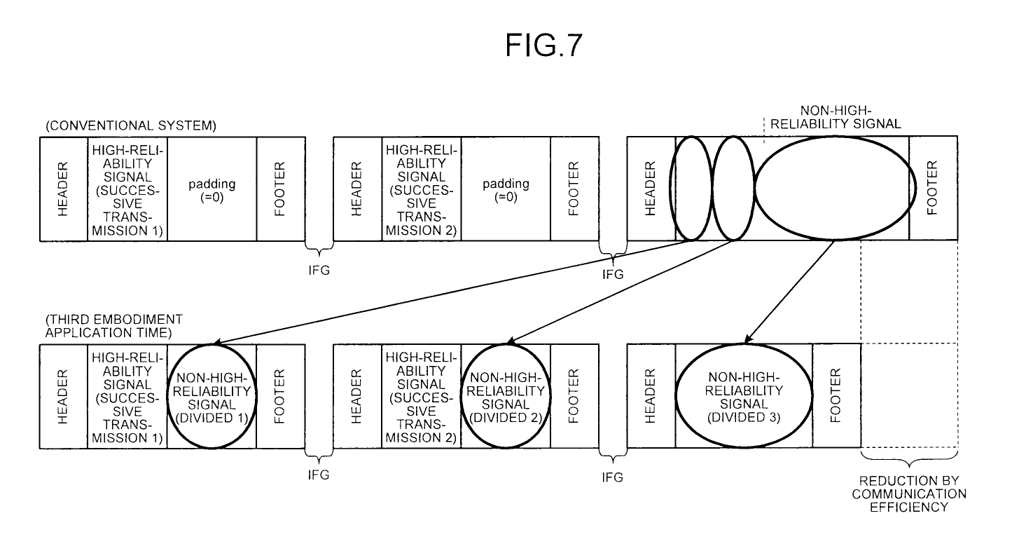

FIG. 7 is a diagram explaining a transmission packet in this embodiment. Packets include headers and footers. IFGs are present among the packets. In the conventional communication system, paddings are respectively included in high-reliability signal packets and the non-high-reliability signal is transmitted as another independent packet. On the other hand, when this embodiment is applied, because a part of the non-high-reliability signal is taken into a high-reliability signal packet, it is possible to improve communication efficiency and reduce the time for which the non-high-reliability signal uses a communication path. In FIG. 7, not all information of the non-high-reliability signal can be stored in the high-reliability signal packet. A part of the information remains as an individual non-high-reliability signal packet. However, when the number of successive transmissions is large or when the size of the non-high-reliability signal is small, it is also possible to store all the information of the non-high-reliability signal in a padding portion in a high-reliability signal packet. In such a case, the transmission packet including the headers and the footers can be reduced. Therefore, an effect of a particularly conspicuous improvement of bandwidth utilization efficiency is obtained.

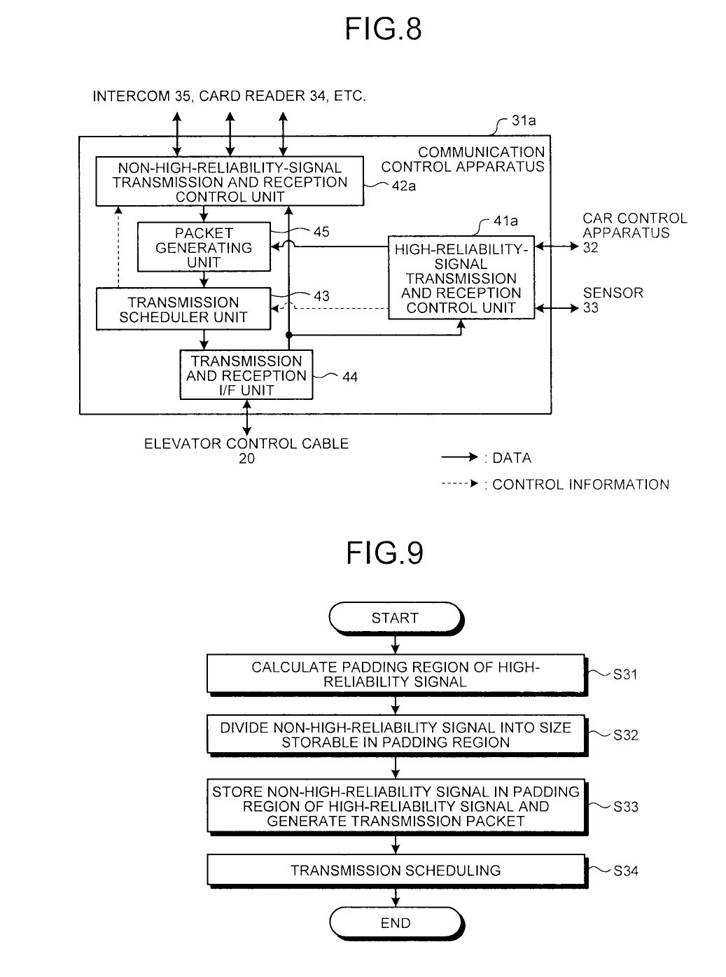

The configuration of the communication control apparatus in this embodiment is explained here. FIG. 8 is a diagram of a configuration example of the communication control apparatus in this embodiment. As in the first and second embodiments, the control panel 10 and the car 30 include communication control apparatuses having the same configuration. As an example, a communication control apparatus 31a in the car 30 is explained. The communication control apparatus 31a includes a high-reliability-signal transmission and reception control unit 41a, a non-high-reliability-signal transmission and reception control unit 42a, the transmission scheduler unit 43, the transmission and reception I/F unit 44, and a packet generating unit 45.

Like the high-reliability-signal transmission and reception control unit 41, the high-reliability-signal transmission and reception control unit 41a generates high-reliability signals. However, the high-reliability-signal transmission and reception control unit 41a transfers an information portion to the packet generating unit 45 without changing the high-reliability signal to a packet form. The high-reliability-signal transmission and reception control unit 41a calculates the size of the padding region when a packet size of the high-reliability signal is smaller than the smallest packet size specified for the communication path to be used.

Like the non-high-reliability-signal transmission and reception control unit 42, the non-high-reliability-signal transmission and reception control unit 42a generates non-high-reliability signals. However, the non-high-reliability-signal transmission and reception control unit 42a transfers the information portion to the packet generating unit 45 without changing the non-high-reliability signal to a packet form. At this point, the non-high-reliability-signal transmission and reception control unit 42a divides the non-high-reliability signal on the basis of the size of the padding region.

The packet generating unit 45 stores the information portion of the high-reliability signal acquired from the high-reliability-signal transmission and reception control unit 41a and the information portion of the non-high-reliability signal acquired from the non-high-reliability-signal transmission and reception control unit 42a in a single packet and generates one transmission packet.

Note that, when the packet generating unit 45 performs integration for increasing a packet size generated by the integration to be equal to or larger than 65 bytes, the communication success probability of the high-reliability signal falls. When such integration is performed, it needs to be noted that setting of the number of successive transmissions of the high-reliability signal needs to be reviewed to be adapted to the increase in the packet size due to the integration. Basically, such packet integration should not be performed.

A communication control method in the communication control apparatus in this embodiment is specifically explained here. FIG. 9 is a flowchart explaining the communication control method of the communication control apparatus in this embodiment. In generating the high-reliability signal, when a packet size of the high-reliability signal is smaller than the smallest packet size specified for a communication path to be used, the high-reliability-signal transmission and reception control unit 41a calculates a padding region for reducing the packet size of the high-reliability signal to the smallest packet size (step S31). The high-reliability-signal transmission and reception control unit 41a transfers the generated high-reliability signal to the packet generating unit 45 without changing the high-reliability signal to a packet form.

When the packet size of a non-high-reliabilty signal is larger than the size of the padding region, the non-high-reliability-signal transmission and reception control unit 42a divides the non-high-reliability signal into a size storable in the padding region and generates a non-high-reliability signal (step S32). The non-high-reliability-signal transmission and reception control unit 42a transfers the generated non-high-reliability signal to the packet generating unit 45 without changing the non-high-reliability signal to a packet form.

The packet generating unit 45 stores the divided non-high-reliability signal in the padding region of the high-reliability signal and generates a transmission packet (step S33).

The transmission scheduler unit 43 performs transmission scheduling for the transmission packet in which the non-high-reliability signal is stored in the padding region of the high-reliability signal (step S34).

As explained above, in this embodiment, when there is a padding region in the transmission packet including only a high-reliability signal, the communication control apparatus divides the non-high-reliability signal into the size of the padding region and transmits information of the high-reliability signal and information of the non-high-reliability signal as one transmission packet. Consequently, it is possible to realize efficient communication of the non-high-reliability signal without affecting communication of the high-reliability signal. Further, it is possible to improve communication efficiency because the bandwidth necessary for transmission can be reduced.

As explained above, the communication control apparatus according to the present invention is useful for communication among apparatuses included in an elevator and, in particular, suitable for communication of different signal types.

### REFERENCE SIGNS LIST

10 Control panel

11 Communication control apparatus

12 Main control apparatus

13 Intercom

20 Elevator control cable

30 Car

31, 31a Communication control apparatuses

32 Car control apparatus

33 Sensors

34 Card reader

35 Intercom

41, 41a High-reliability-signal transmission and reception control units

42, 42a Non-high-reliability-signal transmission and reception control units

43 Transmission scheduler unit

44 Transmission and reception I/F unit

45 Packet generating unit

1. A communication control apparatus that integrates a high-reliability signal requiring high reliability and a non-high-reliability signal not requiring high reliability and performs communication between a car and a control panel configuring an elevator, the communication control apparatus being mounted on the car and the control panel, the communication control apparatus comprising:
a high-reliability-signal transmission and reception control unit configured to perform control for continuously transmitting the high-reliability signal for a specified number of times according to the transmission timing specified within a transmission period;
a transmission scheduler unit configured to calculate, on the basis of the specified transmission timing, a free time in which the high-reliability signal is not transmitted; and
a non-high-reliability-signal transmission and reception control unit configured to perform, when the non-high-reliability signal cannot be transmitted within the free time, control for dividing the non-high-reliability signal into a size transmittable in the free time and for transmitting the non-high-reliability signal as two or more packets, wherein
the transmission scheduler unit transmits the high-reliability signal at the specified transmission timing and transmits the divided non-high reliability signal in the free time.

2. The communication control apparatus according to claim 1, wherein the high-reliability-signal transmission and reception control unit performs control for dispersing the high-reliability signal within the transmission period and transmitting the high-reliability signal.

3. A communication control apparatus that integrates a high-reliability signal requiring high reliability and a non-high-reliability signal not requiring high reliability and performs communication between a car and a control panel configuring an elevator, the communication control apparatus being mounted on the car and the control panel, the communication control apparatus comprising:
a high-reliability-signal transmission and reception control unit configured to perform, in a case in which the high-reliability signal has been received from a counter apparatus, which is a communication partner, when a response to the received high-reliability signal is to be returned to the counter apparatus, control for transmitting the high-reliability signal according to the transmission timing specified within a transmission period;
a transmission scheduler unit configured to calculate, on the basis of the specified transmission timing, a free time in which the high-reliability signal is not transmitted; and
a non-high-reliability-signal transmission and reception control unit configured to perform, when the non-high-reliability signal cannot be transmitted within the free time, control for dividing the non-high-reliability signal into a size transmittable in the free time and transmitting the non-high-reliability signal as two or more packets, wherein
within the transmission period, when the high-reliability signal has not been received from the counter apparatus or the response to the high-reliability signal received from the counter apparatus has not been returned, the non-high-reliability-signal transmission and reception control unit performs control for dividing a packet of the non-high-reliability signal into the smallest size specified for a communication path used for transmission of the non-high-reliability signal and transmitting the packet, and
when the response to the high-reliability signal received from the counter apparatus has been returned, the non-high-reliability-signal transmission and reception control unit sets, as a free time, the time from the return of the response to the start of the next transmission period, performs control for dividing the non-high-reliability signal untransmittable in the free time into a size transmittable in the free time and for transmitting the non-high-reliability signal as two or more packets.

4. The communication control apparatus according to claim 3, wherein
when the response to the high-reliability signal received from the counter apparatus has been returned and a response to the high-reliability signal transmitted from an own apparatus has not been received from the counter apparatus, the non-high-reliability-signal transmission and reception control unit sets, as the free time, time excluding processing time necessary for transmitting the high-reliability signal within the transmission period, and
when the response to the high-reliability signal received from the counter apparatus has been returned and the response to the high-reliability signal transmitted from the own apparatus has been received from the counter apparatus, the non-high-reliability-signal transmission and reception control unit sets, as the free time, the time from the later one of the transmission of the response to the counter apparatus and the reception of the response from the counter apparatus to the start of the next transmission period.

5. The communication control apparatus according to claim 3, wherein, when a response to the high-reliability signal transmitted from an own apparatus has not been received from the counter apparatus, the high-reliability-signal transmission and reception control unit performs control for retransmitting the high-reliability signal through continuous transmission.

6. The communication control apparatus according to claim 4, wherein, when the response to the high-reliability signal transmitted from the own apparatus has not been received from the counter apparatus, the high-reliability-signal transmission and reception control unit performs control for retransmitting the high-reliability signal through continuous transmission.

7. The communication control apparatus according to claim 3, wherein, when a part of the non-high-reliability signal is information having periodicity, the transmission scheduler unit performs scheduling for transmitting a packet storing the information having periodicity at the same timing within the transmission period.

8. The communication control apparatus according to claim 7, wherein, as a result of scheduling the transmission timing of the packet storing the information having periodicity among the high-reliability signal and the non-high-reliability signal, when a time interval for transmitting a packet having the smallest size specified for a communication path to be used does not remain, the transmission scheduler unit changes the transmission timing of the high-reliability signal and reduces the time in which the packet transmission cannot be performed.

9. A communication control apparatus that integrates a high-reliability signal requiring high reliability and a non-high-reliability signal not requiring high reliability and performs communication between a car and a control panel configuring an elevator, the communication control apparatus being mounted on the car and the control panel, the communication control apparatus comprising:
a high-reliability-signal transmission and reception control unit configured to calculate, when performing control for transmitting the high-reliability signal according to transmission timing specified within a transmission period, when a packet size of the high-reliability signal is smaller than the smallest packet size specified by a communication path to be used, a padding region for reducing the packet size of the high-reliability signal to the smallest packet size;
a non-high-reliability-signal transmission and reception control unit configured to divide, when a packet size of the non-high-reliability signal is larger than the size of the padding region, the non-high-reliability signal into a size storable in the padding region;
a packet generating unit configured to store the divided non-high-reliability signal in the padding region of the high-reliability signal and generate a transmission packet; and
a transmission scheduler unit configured to perform transmission scheduling for the transmission packet in which the non-high-reliability signal is stored in the padding region of the high-reliability signal.

10. The communication control apparatus according to claim 9, wherein, when the high-reliability signal is continuously transmitted for a specified number of times at the transmission timing specified within the transmission period, the packet generating unit stores different non-high-reliability signals or different divided non-high-reliability signals in the padding region of each continuously transmitted high-reliability signal and generates the transmission packet.

11-20. (canceled)

21. The communication control apparatus according to claim 1, wherein, when a part of the non-high-reliability signal is information having periodicity, the transmission scheduler unit performs scheduling for transmitting a packet storing the information having periodicity at the same timing within the transmission period.

22. The communication control apparatus according to claim 21, wherein, as a result of scheduling the transmission timing of the packet storing the information having periodicity among the high-reliability signal and the non-high-reliability signal, when a time interval for transmitting a packet having the smallest size specified for a communication path to be used does not remain, the transmission scheduler unit changes the transmission timing of the high-reliability signal and reduces the time in which the packet transmission cannot be performed.
